(19) United States
(12) Patent Application Publication
(10) Pub. No.: US 2013/0313164 A1
(43) Pub. Date: Nov. 28, 2013

(54) SODIUM TOLERANT ZEOLITE CATALYSTS AND PROCESSES FOR MAKING THE SAME

(71) Applicants: Yuying Shu, Ellicott City, MD (US); Richard Franklin Wormsbecher, Dayton, MD (US); Wu-Cheng Cheng, Ellicott City, MD (US)

(72) Inventors: Yuying Shu, Ellicott City, MD (US); Richard Franklin Wormsbecher, Dayton, MD (US); Wu-Cheng Cheng, Ellicott City, MD (US)

(73) Assignee: W.R. Grace & Co. - CONN, Columbia, MD (US)

(21) Appl. No.: 13/988,854

(22) PCT Filed: Nov. 22, 2011
(86) PCT No.: PCT/US11/61762

§ 371 Date: Aug. 14, 2013

Related U.S. Application Data
(60) Provisional application No. 61/416,911, filed on Nov. 24, 2010.

(51) Int. Cl. B01J 29/08

(52) U.S. Cl. CPC B01J 29/088
USPC 208/120.01; 502/73; 502/65

(57) ABSTRACT

This invention relates to a process of preparing a catalyst from zeolite having a relatively high content of sodium of 18.6 μg Na₂O per zeolite surface area, or greater. The invention comprises adding yttrium compound to the zeolite, either prior to, during, or after its combination with precursors for catalyst matrix. This invention is suitable for preparing zeolite containing fluid cracking catalysts.

### RELATED APPLICATIONS

This application claims priority and the benefit of the filing date of U.S. Provisional Patent Application No. 61/416,911 filed Nov. 24, 2010, the disclosure of which is hereby incorporated herein by reference

### FIELD OF THE INVENTION

The present invention relates to catalysts suitable for use in fluid catalytic cracking processes. The invention is particularly relevant to zeolite-containing catalysts wherein the zeolite has relatively high levels of sodium. The invention further relates to manufacturing catalysts using such zeolites, and use of the same in fluid catalytic cracking processes.

### BACKGROUND OF THE INVENTION

Catalytic cracking is a petroleum refining process that is applied commercially on a very large scale. A majority of the refinery petroleum products are produced using the fluid catalytic cracking (FCC) process. An FCC process typically involves the cracking of heavy hydrocarbon feedstocks to lighter products by contacting the feedstock in a cyclic catalyst recirculation cracking process with a circulating fluidizable catalytic cracking catalyst inventory comprising particles having a mean particle size ranging from about 20 to about 150 μm, preferably from about 50 to about 100 μm.

The catalytic cracking occurs when relatively high molecular weight hydrocarbon feedstocks are converted into lighter products by reactions taking place at elevated temperature in the presence of a catalyst, with the majority of the conversion or cracking occurring in the vapor phase. The feedstock is converted into gasoline, distillate and other liquid cracking products as well as lighter gaseous cracking products of four or less carbon atoms per molecule. The gas partly consists of olefins and partly of saturated hydrocarbons. Bottoms and coke are also produced. The cracking catalysts typically are prepared from a number of components, each of which is designed to enhance the overall performance of the catalyst. Zeolitic materials are the primary components in most FCC catalysts used today.

Zeolites, however, are subject to deactivation with respect to catalytic activity in FCC processes when exposed to various contaminants, and in particular when exposed to sodium. Sodium leads to loss of zeolite crystallinity, and this loss is further exacerbated if vanadium is also present. See Handbook of Heterogeneous Catalysis, edited by Ertl et al., 2^{nd} Edition, 2008, pp. 2752-2753. Sodium therefore can detrimentally affect gasoline yields, as well as adversely increase bottoms and coke. Sources of sodium contamination not only include sodium present in feedstock run through the FCC unit, but also include sodium present in raw materials added during the manufacture of zeolite, e.g., zeolites used in FCC catalysts are frequently synthetic zeolites made from sodium silicate. Therefore, synthetic zeolites undergo significant exchange processes to lower the sodium content, frequently requiring one to lower the sodium content from amounts such as 13 to 14% by weight sodium that are present in the zeolite just after crystallization, down to levels of 1% or lower. These exchanges can be numerous and are carried out with ammonium, rare earth, or other cations that exchange with the sodium cation present in the zeolite. Such processes can be expensive, and frequently so when utilizing rare earth. Sodium present in feedstock can be removed by desalter units, but these units and their operation add to the costs of processing feedstock. It would therefore be desirable to reduce the expenses incurred by steps traditionally taken to reduce sodium contamination to the FCC catalyst.

### SUMMARY OF THE INVENTION

It has been discovered that adding yttrium compound to a zeolite can improve a zeolite's tolerance to the deactivation effect of sodium. Accordingly, the invention permits one to prepare relatively active catalyst from zeolites comprising sodium, including amounts of sodium above levels that catalyst manufacturers typically target. The invention therefore permits a catalyst manufacturer to utilize zeolites having sodium levels above at least 1.3% by weight sodium, or 18.6 μg Na₂O per square meter (m²) of zeolite surface area, or greater, e.g., amounts in the range of 22 to 50 μg Na₂O per square meter (m²) of zeolite surface area.

One aspect of the invention, therefore, includes a process for making such catalysts by combining the sodium-containing zeolite with a yttrium compound, and forming a catalyst comprising the sodium-containing zeolite and yttrium compound.

The process typically includes further combining the zeolite with inorganic matrix precursors, e.g., such as those selected from the group consisting of alumina, silica, silica alumina, and mixtures thereof. Peptized aluminas, e.g., those from hydrated aluminas such as pseudo boehmite or boehmite, are particularly suitable precursors. Colloidal silica is another particularly suitable precursor, and when using such precursors, the invention would be particularly beneficial since colloidal silicas frequently contain sodium as a result of the raw materials used to make them.

The yttrium compound typically is an yttrium salt soluble in water or in acid, and include yttrium halide, yttrium nitrate, yttrium carbonate, yttrium sulfate, yttrium oxide and yttrium hydroxide.

Other embodiments of the invention include processes in which the yttrium compound and zeolite are introduced to the process as yttrium cations exchanged on zeolite.

The invention is particularly suitable for use with making catalysts comprising synthetic faujasite, including sodium-containing zeolites selected from the group consisting of type Y zeolite, type X zeolite, Zeolite Beta, and heat treated derivatives thereof. USY zeolite is a particularly common zeolite that can be used with this invention. The invention is particularly suitable for use with USY zeolites comprising levels of 18.6 μg sodium per square meter (m²) of zeolite surface area or greater, and/or in amounts in the range of 22 to 50 μg sodium per square meter (m²) of zeolite surface area.

Another aspect of the invention is that compositions comprising relatively high concentrations of sodium can be effectively used as catalyst in FCC processes. Accordingly, the catalyst of this invention comprises:
(a) zeolite,
(b) yttrium compound, and
(c) sodium, wherein the sodium is present in the catalyst at least 1.3% by weight based on the amount of zeolite.
   The zeolite, yttrium compound and ranges of sodium present in these compositions are the same as described above with respect to the process for making the invention. The catalyst composition is typically in particulate form having an average particle size in the range of 20 to 150 microns.

Another aspect of the invention includes use of an yttrium-containing catalyst in a FCC process that is processing feedstock containing relatively high levels of sodium. The invention therefore includes a catalytic cracking process comprising:
(a) introducing a hydrocarbon feedstock into a reaction zone of a catalytic cracking unit comprised of a reaction zone, stripping zone, and a regeneration zone, which feedstock is characterized as having a sodium content in the range of 0.5 to 5 ppm of sodium and having an initial boiling point from about 120° C. with end points up to about 850° C.;
(b) catalytically cracking said feedstock in said reaction zone at a temperature from about 400° C. to about 700° C., by causing the feedstock to be in contact with a fluidizable cracking catalyst comprising:
   (i) zeolite,
   (ii) yttrium in the range of 0.5 to 15% by weight based on the zeolite, and
   (ii) optionally inorganic oxide matrix,
(c) stripping recovered used catalyst particles with a stripping fluid in a stripping zone to remove therefrom some hydrocarbonaceous material; and
(d) recovering stripped hydrocarbonaceous material from the stripping zone and circulating stripped used catalyst particles to the regenerator or regeneration zone; and regenerating said cracking catalyst in a regeneration zone by burning-off a substantial amount of coke on said catalyst, and with any added fuel component to maintain the regenerated catalyst at a temperature which will maintain the catalytic cracking reactor at a temperature from about 400° C. to about 700° C.; and
(e) recycling said regenerated hot catalyst to the reaction zone.

### DETAILED DESCRIPTION OF THE INVENTION

It has been found that adding yttrium compound to a zeolite results in a zeolite that is tolerant to relatively high sodium concentrations, thereby reducing the deactivation effect that sodium typically causes in zeolite-containing FCC catalysts.

Yttrium is commonly found in rare earth ores and has been occasionally referred to as a rare earth metal. Yttrium, however, is not considered, for the purpose of describing this invention, a rare earth metal. The element yttrium has an atomic number of 39, whereas rare earth is typically defined to include elements of the Periodic Table having atomic numbers from 57 to 71. The metals within this range of atomic numbers include lanthanum (atomic number 57) and lanthanide metals. See, Hawley's Condensed Chemical Dictionary, 11^{th} Edition, (1987). The term “rare earth” or “rare earth oxide” is therefore used hereinafter to mean lanthanum and lanthanide metals, or their corresponding oxides. Unless expressed otherwise herein, weight measurements of rare earth elements or a rare earth compound refer to that reported as an oxide in elemental analysis techniques conventionally used in the art, including but not limited to, inductively coupled plasma (ICP) analytical methods.

The term “yttrium compound” is used herein to designate not only yttrium that is in the form of a compound such as a yttrium salt, but also in the form of a yttrium cation such as that exchanged on zeolite. The term “yttrium compound” and the term “yttrium” are used interchangeably unless stated otherwise. Unless expressed otherwise herein, weight measurements of yttrium or an yttrium compound refer to that reported as yttrium oxide (Y₂O₃) in elemental analysis techniques conventionally used in the art, including but not limited to, inductively coupled plasma (ICP) analytical methods.

For purposes of the invention, the term “zeolite surface area” is used herein to refer to surface area in m²/g from a zeolite or microporosity less than 2 nanometers.

The present invention preferably is a catalyst capable of being maintained within a FCC unit. FCC catalysts typically contain zeolite, which is a fine porous powdery material composed of the oxides of silicon and aluminum. The zeolites are typically incorporated into matrix and/or binder and particulated. See “Commercial Preparation and Characterization of FCC Catalysts”, Fluid Catalytic Cracking: Science and Technology, Studies in Surface Science and Catalysis, Vol. 76, p. 120 (1993). When the aforementioned zeolite-containing particulates are aerated with gas, the particulated catalytic material attains a fluid-like state that allows the material to behave like a liquid. This property permits the catalyst to have enhanced contact with the hydrocarbon feedstock feed to the FCC unit and to be circulated between the FCC reactor and the other units of the overall FCC process (e.g., regenerator). Hence, the term “fluid” has been adopted by the industry to describe this material. FCC catalysts typically have average particle sizes in the range of about 20 to about 150 microns.

### Zeolite

The zeolite utilized in this invention can be any zeolite having catalytic activity in a hydrocarbon conversion process. The invention is particularly suitable for zeolites utilized for cracking hydrocarbons into gasoline range products. Such zeolites can be large pore size zeolites that are characterized by a pore structure with an opening of at least 0.7 nm. Catalysts of this invention can comprise zeolite in an amount in the range of 1 to 80% by weight, typically in an amount in the range of 5 to 60% by weight.

Suitable large pore zeolites comprise crystalline alumino-silicate zeolites such as synthetic faujasite, i.e., type Y zeolite, type X zeolite, and Zeolite Beta, as well as heat treated (calcined) derivatives thereof. Zeolites that are particularly suited include ultra stable type Y zeolite (USY) as disclosed in U.S. Pat. No. 3,293,192. As is discussed in more detail below, an yttrium exchanged Y zeolite is particularly suitable. The zeolite of this invention may also be blended with molecular sieves such as SAPO and ALPO as disclosed in U.S. Pat. No. 4,764,269. The above zeolites that have been pre-exchanged with rare earth may also be used with this invention, although they are not preferred, especially those zeolites that have undergone extensive rare earth exchange.

Standard Y-type zeolite is commercially produced by crystallization of sodium silicate and sodium aluminate. This zeolite can be converted to USY-type by dealumination, which increases the silicon/aluminum atomic ratio of the parent standard Y zeolite structure. Dealumination can be achieved by steam calcination or by chemical treatment.

The unit cell size of a preferred fresh Y-zeolite is about 2.445 to 2.470 nm (24.45 to 24.7 Å). The unit cell size (UCS) of zeolite can be measured by X-ray diffraction analysis under the procedure of ASTM D3942. There is normally a direct relationship between the relative amounts of silicon and aluminum atoms in the zeolite and the size of its unit cell. This relationship is fully described in Zeolite Molecular Sieves, Structural Chemistry and Use (1974) by D. W. Breck at Page 94, which teaching is incorporated herein in its entirety by reference. Although both the zeolite, per se, and the matrix of a fluid cracking catalyst usually contain both silica and alumina, the SiO₂/Al₂O₃ ratio of the catalyst matrix should not be confused with that of the zeolite. When an equilibrium catalyst is subjected to x-ray analysis, it only measures the UCS of the crystalline zeolite contained therein.

The unit cell size value of a zeolite also decreases as it is subjected to the environment of the FCC regenerator and reaches equilibrium due to removal of the aluminum atoms from the crystal structure. Thus, as the zeolite in the FCC inventory is used, its framework Si/A1 atomic ratio increases from about 3:1 to about 30:1. The unit cell size correspondingly decreases due to shrinkage caused by the removal of aluminum atoms from the cell structure. The unit cell size of a preferred equilibrium Y zeolite is at least 2.422 nm (24.22 Å), preferably from 2.424 to 2.450 nm (24.24 to 24.50 Å), and more preferably from 2.426 to 2.438 nm (24.26 to 24.38 Å).

The zeolite can be one capable of being cation exchanged with yttrium. As described in more detail below, yttrium exchanged zeolites that can be used in the invention are prepared by ion exchange, during which cations, e.g., that of sodium or ammonium, present in the zeolite structure are replaced with yttrium cations, preferably prepared from yttrium rich compounds. The yttrium compound used to conduct the exchange may also be mixed with rare-earth metal salts such as those salts of cerium, lanthanum, neodymium, erbium, dysprosium, holmium, thulium, lutetium, and ytterbium, naturally occurring rare-earths and mixtures thereof. It is particularly preferable for embodiments utilizing yttrium exchanged zeolite that the yttrium exchange bath primarily comprises yttrium, preferably with no more than 50% by weight rare earth present in the yttrium compound, and more preferably no more than 25% by weight. The yttrium exchanged zeolites may be further treated by drying and calcination (e.g., in steam) before further processing the zeolite further.

### Yttrium

Yttrium can be present in the catalyst composition in amounts ranging from about 0.5 to about 15% by weight of the zeolite. The specific amount of yttrium for a particular embodiment depends on a number of factors, including, but not limited to, the ion exchange capacity of the selected zeolite in embodiments utilizing yttrium exchanged zeolite. Embodiments comprising higher amounts of yttrium can include yttrium that is not exchanged on the zeolite. Embodiments that are particularly suitable for this invention comprise 0.5 to about 9% by weight yttrium of the zeolite.

The amount of yttrium in the formed catalyst can also be reported as an oxide in amounts in grams per square meter of catalyst surface area. For example, yttrium can be present in amounts of at least about 5 μg/m² of total catalyst surface area. More typically, yttrium can be found in amounts of at least about 10 μg/m² to 200 μg/m².

It is generally desirable for yttrium to be located within the pores of the zeolite, which results when exchanging yttrium onto zeolite. It is also possible that a portion of the yttrium can be located within pores of the catalyst matrix after the zeolite is combined with matrix precursors, i.e., at the relatively higher amounts of yttrium in the range described above. The presence of yttrium in the catalyst matrix is typically found in embodiments of the invention in which yttrium compound is added to the zeolite in a slurry of zeolite, peptized alumina, and optional components that is then processed to form the final catalyst material.

Yttrium can be added to a combination or mixture of zeolite and peptized alumina using soluble yttrium salts, which include yttrium halides (e.g., chlorides, fluorides, bromides and iodides), nitrates, acetates, bromates, iodates, and sulfates. Water soluble salts, and aqueous solutions thereof, are particularly suitable for use in this invention. Acid soluble compounds, e.g., yttrium oxide, yttrium hydroxide, yttrium fluoride and yttrium carbonate, are also suitable for embodiments in which the salt is added with acid, e.g., when acid and alumina are combined with acid stable zeolite and peptized alumina is formed in situ. Yttrium oxychlorides are also suitable sources of yttrium.

The soluble salts of this embodiment are added as solution having an yttrium concentration in the range of 1 to about 40% by weight. If the yttrium source is from a rare earth ore, salts of rare earth may also be present in the yttrium compound and/or yttrium exchange bath. For example, typical yttrium compounds suitable for this invention could comprise rare earth elements in a weight ratio of in the range of 0.01 to 1 rare earth to yttrium, but more typically in the range of 0.05 to 0.5. It is preferable, however, that the yttrium compound consists essentially of yttrium-containing moieties, and any amount of rare earth is minimal and preferably present in amounts so that no more than 5% by weight based on the zeolite is present in the catalyst.

### Effect of Sodium Concentrations

The yttrium added pursuant to this invention imparts sodium tolerance to the zeolite, and therefore sodium levels in catalysts, especially catalysts suitable for FCC processes, can be higher than conventionally accepted. For example, the sodium content of conventional catalysts is frequently reduced to levels of 1% or less, or alternatively expressed as 14 μg sodium per square meter of zeolite surface area, or less. The examples below, however, indicate that yttrium can reduce the effect of sodium at levels greater than 1% by weight zeolite. Specifically, significant advantages can be shown when utilizing yttrium in connection with zeolites containing sodium at levels greater than 18 μg sodium per square meter zeolite, including but not limited to amounts in the range of 22 to 50 μg sodium. This effect is especially surprising since yttrium does not appear to provide the same scale of sodium tolerance, if any, to zeolites containing the conventional lower levels of sodium. Zeolite surface area used in the above measurements are measured on the final catalyst using Marvin Johnson t-plot analysis. See “Estimation of the Zeolite Content of a Catalyst from Nitrogen Adsorption Isotherms”, Journal of Catalysis, Vol. 52, pp 425-431 (1978). Zeolite content of the catalyst is calculated from t-plot analysis assuming standard zeolite surface area of 700 m²/g. See ASTM Method D-4365-95. Unless expressed otherwise herein, weight measurements of sodium refer to that reported as Na₂O in elemental analysis techniques conventionally used in the art, including but not limited to, inductively coupled plasma (ICP) analytical methods.

### Inorganic Oxide Matrix Precursors

Precursors for catalyst matrix and/or catalyst binders can be combined with the zeolite and yttrium compound. Suitable matrix precursor materials are those inorganic oxide materials that, when added to the other catalyst components and then processed to form final catalyst, creates a matrix of material that provides surface area and bulk to the final catalyst form. Suitable material includes material that forms active matrices, and include, but are not limited to, alumina, silica, porous alumina-silica, and kaolin clay. Alumina is preferred for some embodiments of the invention, and may form all or part of an active-matrix component of the catalyst. By “active” it is meant the material has activity in converting and/or cracking hydrocarbons in a typical FCC process.

Peptized aluminas are also particularly suitable matrix precursors. See for example, U.S. Pat. Nos. 7,208,446; 7,160,830; and 7,033,487. Peptized alumina herein specifically refers to alumina peptized with an acid and may also be called “acid peptized alumina” For purposes of the present invention, the term “peptized alumina” is used herein to designate aluminas that have been treated with acid in a manner that fully or partially breaks up the alumina into a particle size distribution with an increased number of particles that are less than one micron in size. Peptizing typically results in a stable suspension of particles having increased viscosity. See Morgado et. al., “Characterization of Peptized Boehmite Systems An ²⁷Al Nuclear Magnetic Resonance Study”, J. Coll. Interface Sci., 176, 432-441 (1995). Peptized alumina dispersions typically have an average particle size less than that of the starting alumina, and are typically prepared using acid concentrations described later below.

Acid peptized alumina is prepared from an alumina capable of being peptized, and would include those known in the art as having high peptizability indices. See U.S. Pat. No. 4,086,187; or alternatively those aluminas described as peptizable in U.S. Pat. No. 4,206,085. Suitable aluminas include those described in column 6, line 57 through column 7, line 53 of U.S. Pat. No. 4,086,187, the contents of which are incorporated by reference.

Suitable precursors of binders include those materials capable of binding the matrix and zeolite into particles. Specific suitable binders include, but are not limited to, alumina sols (e.g., aluminum chlorohydrol), silica sols, aluminas, and silica aluminas Modified clays, such as acid leached clays, are also suitable for use in this invention.

### Optional Components

The invention can comprise additional inorganic oxide components that also serve as matrix and/or that can serve other functions, e.g., binder and metals trap. Suitable additional inorganic oxide components include, but are not limited to, unpeptized bulk alumina, silica, porous alumina-silica, and kaolin clay.

Binders and matrix permit formation of attrition resistant particles suitable for use in FCC processes. Suitable particles made from the processes described below typically have attrition resistance in the range of 1 to 20 as measured by the Davison Attrition Index. To determine the Davison Attrition Index (DI) of the invention, 7.0 cc of sample catalyst is screened to remove particles in the 0 to 20 micron range. Those remaining particles are then contacted in a hardened steel jet cup having a precision bored orifice through which an air jet of humidified (60%) air is passed at 21 liter/minute for 1 hour. The DI is defined as the percent of 0-20 micron fines generated during the test relative to the amount of >20 micron material initially present, i.e., the formula below.

DI=100×(wt % of 0-20 micron material formed during test)/(wt of original 20 microns or greater material before test).

### Process of Making the Catalyst

The process for this invention comprises combining the zeolite, yttrium compound and optionally additional inorganic oxide precursors. The process in which these components are combined can vary. The processes include, but are not necessarily limited to, the following.
(1) Adding yttrium after a zeolite has been exchanged with ammonium, the addition of yttrium occurring before combination with the optional inorganic oxide precursors, and then forming a catalyst therefrom.
(2) Exchanging yttrium onto zeolite, with optional ammonium exchange thereafter, and then combining the yttrium exchanged zeolite with optional components, and forming the desired catalyst.
(3) Combining an ammonium exchanged zeolite with yttrium compound and optional inorganic oxide precursors, and then forming the desired catalyst.
(4) Adding yttrium compound to a sodium Y zeolite prior to ultrastabilization, and then further processing the zeolite for ultrastabilization, followed by an ammonium exchange, after which the yttrium containing, ultrastabilized Y zeolite is combined with optional components and the desired catalyst is formed.

Adding yttrium to the zeolite in any of the above processes permits a catalyst manufacturer to have a wider sodium specification for its zeolite and/or catalyst, while still achieving acceptable catalytic activity, as well as reduces expense and costs associated with ammonium exchange, e.g., ammonium utilization amounts and recovery expenses. For example, ammonium exchange of a sodium Y zeolite to levels of 1% or less require amounts of ammonium well in excess of stoichiometric amounts. If, however, one only has to exchange to sodium amounts of about 2% by weight based on the zeolite, the amount of ammonium used can be closer to stoichiometric amounts. Accordingly, one can prepare effective zeolite catalysts using not only smaller amounts of ammonium, but one incurs smaller ammonia recovery costs to recover the excess ammonia typically utilized when reducing sodium levels to 1% or less.

Spray drying is one process that can be used in any of the above-described methods to form the catalyst. Spray drying conditions are known in the art. For example, after combining the yttrium exchanged zeolite of (1) with inorganic oxide precursors in water, the resulting slurry can be spray dried into particles having an average particle size in the range of about 20 to about 150 microns. The inlet temperature of the spray drier can be in the range of 220° C. to 540° C., and the outlet temperature is in the range of 130° C. to 210° C.

As mentioned earlier, the source of yttrium in any of the above methods is generally in the form of an yttrium salt, and the yttrium compound is present at concentrations of about 1 to about 50%.

In the event that matrix and/or binder precursors are included, these materials can be added to the mixture as dispersions, solids, and/or solutions. A suitable clay matrix comprises kaolin. Suitable materials for binders include inorganic oxides, such as alumina, silica, silica-alumina, aluminum phosphate, as well as other metal-based phosphates known in the art. Silica sols such as Ludox® colloidal silica available from W. R. Grace & Co.-Conn. and ion exchanged water glass are suitable binders. Certain binders, e.g., those formed from binder precursors, e.g., aluminum chlorohydrol, are created by introducing solutions of the binder's precursors into the mixer, and the binder is then formed upon being spray dried and/or further processed.

It is optional to wash the catalyst after it is formed, e.g., to remove any residual excess alkali metal. For example, catalysts prepared utilizing silica sol based binders typically require a post wash or exchange, because silica sol or colloidal silica binders are prepared from sodium silicate. The catalyst can be washed one or more times, preferably with water, ammonium hydroxide, and/or aqueous ammonium salt solutions, such as ammonium sulfate solution. The washed catalyst is separated from the wash slurry by conventional techniques, e.g. filtration, and dried to lower the moisture content of the particles to a desired level, typically at temperatures ranging from about 100° C. to 300° C. These exchanges, however, also remove rare earth that may have been previously exchanged onto the zeolite. Since the rare earth acts to stabilize the zeolite, it would therefore be preferable to reduce or eliminate this post exchange. It is believed the addition of yttrium can assist the catalyst manufacturer in meeting this goal.

A spray dried catalyst can also be used as a finished catalyst “as is”, or it can be calcined for activation prior to use. The catalyst particles, for example, can be calcined at temperatures ranging from about 250° C. to about 800° C. for a period of about 10 seconds to about 4 hours. Preferably, the catalyst particles are calcined at a temperature of about 350° C. to 600° C. for about 10 seconds to 2 hours.

The invention prepares catalyst that can be used as a catalytic component of the circulating inventory of catalyst in a catalytic cracking process, e.g., an FCC process. For convenience, the invention will be described with reference to the FCC process although the present catalyst could be used in a moving bed type (TCC) cracking process with appropriate adjustments in particle size to suit the requirements of the process. Apart from the addition of the present catalyst to the catalyst inventory and some possible changes in the product recovery section, discussed below, the manner of operating a FCC process will not be substantially different.

The invention is, however, particularly suited for FCC processes in which a hydrocarbon feed will be cracked to lighter products by contact of the feed in a cyclic catalyst recirculation cracking process with a circulating fluidizable catalytic cracking catalyst inventory consisting of particles having a size ranging from about 20 to about 150 microns. The significant steps in the cyclic process are: (i) the feed is catalytically cracked in a catalytic cracking zone, normally a riser cracking zone, operating at catalytic cracking conditions by contacting feed with a source of hot, regenerated cracking catalyst to produce an effluent comprising cracked products and spent catalyst containing coke and strippable hydrocarbons; (ii) the effluent is discharged and separated, normally in one or more cyclones, into a vapor phase rich in cracked product and a solids rich phase comprising the spent catalyst; (iii) the vapor phase is removed as product and fractionated in the FCC main column and its associated side columns to form liquid cracking products including gasoline, (iv) the spent catalyst is stripped, usually with steam, to remove occluded hydrocarbons from the catalyst, after which the stripped catalyst is oxidatively regenerated to produce hot, regenerated catalyst which is then recycled to the cracking zone for cracking further quantities of feed.

Typical FCC processes are conducted at reaction temperatures of about 480° C. to about 570° C., preferably 520 to 550° C. The regeneration zone temperatures will vary depending on the particular FCC unit. As it is well known in the art, the catalyst regeneration zone may consist of a single or multiple reactor vessels. Generally, the regeneration zone temperature ranges from about 650 to about 760° C., preferably from about 700 to about 730° C.

The stripping zone can be suitably maintained at a temperature in the range from about 470 to about 560° C., preferably from about 510 to about 540° C.

Catalysts employed in FCC processes are frequently added to the circulating FCC catalyst inventory while the cracking process is underway, or they may be present in the inventory at the start-up of the FCC operation. As will be understood by one skilled in the art, the catalyst particles may alternatively be added directly to the cracking zone, to the regeneration zone of the FCC cracking apparatus, or at any other suitable point in the FCC process.

Other catalytically active components may be present in the circulating inventory of catalytic material in addition to a cracking catalyst prepared by this invention and/or may be included with the invention when the invention is being added to a FCC unit. Examples of such other materials include the octane enhancing catalysts based on zeolite ZSM-5, CO combustion promoters based on a supported noble metal such as platinum, stack gas desulfurization additives such as DESOX® additive (magnesium aluminum spinel), vanadium traps, bottom cracking additives, such as those described in Krishna, Sadeghbeigi, op cit and Scherzer, “Octane Enhancing Zeolitic FCC Catalysts”, Marcel Dekker, N.Y., 1990, ISBN 0-8247-8399-9, pp. 165-178 and gasoline sulfur reduction products such as those described in U.S. Pat. No. 6,635,169. These other components may be used in their conventional amounts.

This invention is particularly useful when utilizing zeolite or other catalyst components containing relatively high levels of sodium. It is submitted that the benefit of the invention is unexpected. The examples below show that when yttrium replaces rare earth as a component to the catalyst, and is added to a catalyst, a tolerance to high level of sodium is exhibited, whereas a catalyst exchanged with lanthanum does not show the benefit and indeed, shows the deactivation effect typically experienced when sodium is present at relatively high sodium levels. The above in turn provides further benefits exhibited in manufacturing the catalysts, e.g., requiring less ammonium exchange onto the zeolite. As described earlier, the invention would also be suitable for a petroleum refinery that is faced with potentially running a high sodium feedstock through its FCC unit, e.g., the refinery's desalting unit is malfunctioning or down for repairs. For example, particularly suitable catalysts for cracking feedstock having sodium contents in the range of 0.5 to 5 ppm sodium comprise (i) zeolite, (ii) yttrium in the range of 0.5 to 15% by weight based on the zeolite, and (iii) optionally inorganic oxide matrix. It would also be particularly useful to use relatively low sodium containing catalysts (compared to other embodiments described herein) to enhance the sodium tolerance effect of the yttrium. Embodiments of the invention for cracking high sodium feeds therefore would preferably comprise sodium in amounts of 14 μg sodium per square meter of zeolite surface area or less.

It is also within the scope of the invention to use the cracking catalyst compositions of the invention alone or in combination with other conventional FCC catalysts include, for example, zeolite based catalysts with a faujasite cracking component as described in the seminal review by Venuto and Habib, Fluid Catalytic Cracking with Zeolite Catalysts, Marcel Dekker, New York 1979, ISBN 0-8247-6870-1 as well as in numerous other sources such as Sadeghbeigi, Fluid Catalytic Cracking Handbook, Gulf Publ. Co. Houston, 1995, ISBN 0-88415-290-1.

To further illustrate the present invention and the advantages thereof, the following specific examples are given. The examples are given as specific illustrations of the claimed invention. It should be understood, however, that the invention is not limited to the specific details set forth in the examples.

All parts and percentages in the examples as well as the remainder of the specification that refers to solid compositions or concentrations are by weight unless otherwise specified. However, all parts and percentages in the examples as well as the remainder of the specification referring to gas compositions are molar or by volume unless otherwise specified.

Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited.

### EXAMPLES

The composition of the yttrium solution and lanthanum solution used in the Examples below contain elements as indicated in Table 1 below. The solutions are aqueous based, and RE₂O₃ refers to total content of lanthanum and lanthanide metals, with the content of lanthanum and lanthanide metal, if present, separately listed following the entry for RE₂O₃. Each element is reported below as an oxide.

TABLE 1

| Sample | | |
|---|---|---|
| Comments: | LaCl₃ Solution | YCl₃ Solution |
| Y₂O₃, %: | 0.01 | 22.8 |
| RE₂O₃, %: | 27.07 | 1.52 |
| La₂O₃, %: | 17.92 | 0.03 |
| Dy₂O₃ | 0 | 0.01 |
| Er₂O₃ | 0 | 0.62 |
| Ho₂O₃ | 0 | 0.29 |
| Yb₂O₃ | 0 | 0.34 |
| CeO₂, %: | 3.42 | 0.01 |
| Na₂O, %: | 0.27 | 0.43 |
| Nd₂O₃, %: | 1.28 | 0.01 |
| Pr₆O₁₁, %: | 0.81 | 0 |
| Sm₂O₃, %: | 1.23 | 0 |

Three USY zeolite samples were used in the Examples below and their elemental analysis are listed in Table 2 below. The relative Na₂O wt % for zeolite 1, 2, and 3 are 0.19, 1.55, and 2.25%, respectively.

TABLE 2

| Description: | Zeolite 1 | Zeolite 2 | Zeolite 3 |
|---|---|---|---|
| Na₂O, %: | 0.19 | 1.55 | 2.25 |
| Al₂O₃, %: | 23.1 | 20.2 | 20.5 |
| La₂O₃, %: | 0.01 | 0.05 | 0.04 |
| RE₂O₃, %: | 0.02 | 0.07 | 0.06 |
| SiO₂, %: | 75.9 | 77.4 | 76.9 |

### Example 1

Catalyst 1 is made from the above lanthanum solution with Zeolite 1 described above. Aqueous solutions of 5856 grams (1558 g on a dry base) of the Zeolite 1, 3478 grams (800 g on a dry basis) of aluminum chlorohydrol, 947 grams (500 g on a dry basis) of alumina, 2471 grams (2100 g on a dry basis) of clay, and 370 grams (100 g on a dry basis) lanthanum solution were added and mixed for about 10 minutes. The mixture was milled in a Drais mill to reduce particle size and spray dried in a Bowen spray dryer at an inlet temperature of 343° C. The spray dried particles were calcined for 1 hour at 593° C.

### Example 2

Catalyst 2 is made with Zeolite 2 and the lanthanum solution described above. Aqueous solutions of 11194 grams (3071 g on a dry base) of the Zeolite 2, 5565 grams (1280 g on a dry basis) of aluminum chlorohydrol, 1515 grams (800 g on a dry basis) of alumina, 3388 grams (2880 g on a dry basis) of clay, and 593 grams (160 g on a dry basis) lanthanum solution were added and mixed for about 10 minutes. The mixture was milled in a Drais mill to reduce particle size and spray dried in a Bowen spray dryer at an inlet temperature of 343° C. The spray dried particles were calcined for 1 hour at 593° C. The catalyst is referred to below as Catalyst 2.

### Example 3

Catalyst 3 is made similarly as Catalyst 2 except the Zeolite 3 was used to replace Zeolite 2. Aqueous solutions of 11194 grams (3071 g on a dry base) of the Zeolite 3, 5565 grams (1280 g on a dry basis) of aluminum chlorohydrol, 1515 grams (800 g on a dry basis) of alumina, 3388 grams (2880 g on a dry basis) of clay, and 593 grams (160 g on a dry basis) lanthanum solution were added and mixed for about 10 minutes. The mixture was milled in a Drais mill to reduce particle size and spray dried in a Bowen spray dryer at an inlet temperature of 343° C. The spray dried particles were calcined for 1 hour at 593° C. The catalyst is referred to below as Catalyst 3.

### Example 4

Catalyst 4 is made from the yttrium solution with the Zeolite 1 described above. Aqueous solutions of 5856 grams (1558 g on a dry base) of the Zeolite 1, 3478 grams (800 g on a dry basis) of aluminum chlorohydrol, 947 grams (500 g on a dry basis) of alumina, 2471 grams (2100 g on a dry basis) of clay, and 307 grams (70 g on a dry basis) yttrium solution were added and mixed for about 10 minutes. The mixture was milled in a Drais mill to reduce particle size and spray dried in a Bowen spray dryer at an inlet temperature of 343° C. The spray dried particles were calcined for 1 hour at 593° C. The catalyst is referred to below as Catalyst 4.

### Example 5

Catalyst 5 is made from the above yttrium solution with the Zeolite 2 described above. Aqueous solutions of 11126 grams (3071 g on a dry base) of the Zeolite 2, 5565 grams (1280 g on a dry basis) of aluminum chlorohydrol, 1515 grams (800 g on a dry basis) of alumina, 3388 grams (2880 g on a dry basis) of clay, and 491 grams (112 g on a dry basis) yttrium solution were added and mixed for about 10 minutes. The mixture was milled in a Drais mill to reduce particle size and spray dried in a Bowen spray dryer at an inlet temperature of 343° C. The spray dried particles were calcined for 1 hour at 593° C. The catalyst is referred to below as Catalyst 5.

### Example 6

Catalyst 6 was prepared similarly as Catalyst 5 except the Zeolite 2 was replaced with the Zeolite 3 described above. Aqueous solutions of 11126 grams (3071 g on a dry base) of the Zeolite 3, 5565 grams (1280 g on a dry basis) of aluminum chlorohydrol, 1515 grams (800 g on a dry basis) of alumina, 3388 grams (2880 g on a dry basis) of clay, and 491 grams (112 g on a dry basis) yttrium solution were added and mixed for about 10 minutes. The mixture was milled in a Drais mill to reduce particle size and spray dried in a Bowen spray dryer at an inlet temperature of 343° C. The spray dried particles were calcined for 1 hour at 593° C. The catalyst is referred to below as Catalyst 6.

### Example 7

The physical and chemical properties of Catalysts 1, 2 and 3 (fresh and after CPS no metals deactivation) are listed on Table 3 below. The physical and chemical properties (fresh) of Catalysts 1, 2 and 3 are listed on Table 3 below.

The following acronyms or abbreviations appearing in the tables below are defined as follows:

| | |
|---|---|
| ZSA = zeolite surface area | ABD = average bulk density |
| DI = Davison attrition index | APS = average particle size |
| MSA = matrix surface area | LCO = light cycle oil |

TABLE 3

| | Catalyst 1 | Catalyst 2 | Catalyst 3 |
|---|---|---|---|
| | Made with | Made with | Made with |
| | Zeolite 1 | Zeolite 2 | Zeolite 3 |
| Sample Properties: | and La | and La | and La |
| Al₂O₃, %: | 48.9 | 47.6 | 48.4 |
| La₂O₃, %: | 1.9 | 1.9 | 1.9 |
| Na₂O, %: | 0.21 | 0.57 | 0.80 |
| RE₂O₃, %: | 2.0 | 2.0 | 2.0 |
| Y₂O₃, %: | 0.01 | 0.00 | 0.00 |
| Na₂O on Zeolite (μg/m²) | 8.7 | 22.8 | 32.5 |
| ABD, g/cm³: | 0.69 | 0.65 | 0.66 |
| DI: | 5 | 4 | 3 |
| Pore Volume, cm³/g: | 0.40 | 0.48 | 0.46 |
| Surface Area, m²/g: | 290 | 307 | 303 |
| ZSA, m²/g: | 243 | 248 | 246 |
| MSA, m²/g: | 47 | 59 | 57 |
| After CPS-1 No Metals | | | |
| Surface Area, m²/g: | 180 | 185 | 161 |
| ZSA, m²/g: | 149 | 143 | 121 |
| MSA, m²/g: | 31 | 42 | 40 |

### Example 8

The physical and chemical properties of Catalysts 4, 5 and 6 (fresh and after CPS no metals deactivation) are listed on Table 4 below.

TABLE 4

| | Catalyst 4 | Catalyst 5 | Catalyst 6 |
|---|---|---|---|
| | Made with | Made with | Made with |
| | Zeolite 1 | Zeolite 2 | Zeolite 3 |
| Sample Properties: | and Y | and Y | and Y |
| Al₂O₃, %: | 47.9 | 48.3 | 46.3 |
| La₂O₃, %: | 0.05 | 0.07 | 0.04 |
| Na₂O, %: | 0.20 | 0.62 | 0.85 |
| RE₂O₃, %: | 0.07 | 0.07 | 0.04 |
| Y₂O₃, %: | 1.4 | 1.4 | 1.3 |
| Na₂O on Zeolite (μg/m²) | 8.4 | 24.5 | 34.9 |
| ABD, g/cm³: | 0.71 | 0.66 | 0.67 |
| DI: | 4 | 3 | 3 |
| Pore Volume, cm³/g: | 0.42 | 0.46 | 0.45 |
| Surface Area, m²/g: | 289 | 306 | 301 |
| ZSA, m²/g: | 239 | 251 | 245 |
| MSA, m²/g: | 50 | 55 | 57 |
| After CPS-1 No Metals | | | |
| Surface Area, m²/g: | 185 | 191 | 168 |
| ZSA, m²/g: | 149 | 148 | 126 |
| MSA, m²/g: | 36 | 43 | 42 |

It is shown that zeolite surface area (ZSA) obtained for the yttrium containing catalysts of 5 and 6 is higher compared to their La counterparts of 2 and 3. This indicates that the yttrium catalysts are more sodium tolerant as compared to their La counterparts.

### Example 9

All 6 deactivated catalysts described above were evaluated in an ACE Model AP Fluid Bed Microactivity unit from Kayser Technology, Inc. See also, U.S. Pat. No. 6,069,012. The reactor temperature was 527° C. The results of the studies appear in Table 5 below.

Deactivation was conducted pursuant to L. T. Boock, T. F. Petti, J. A. Rudesill; Deactivation and Testing of Hydrocarbon-Processing Catalysts, P. O'Connor, T. Takatsuka, G. L. Woolery (Eds.), ACS Symposium Series, Vol. 634, American Chemical Society, Washington, D.C., 1996, p. 171.

TABLE 5
Conversion 76

| | Catalyst 1 | Catalyst 2 | Catalyst 3 | Catalyst 4 | Catalyst 5 | Catalyst 6 |
|---|---|---|---|---|---|---|
| | Made with | Made with | Made with | Made with | Made with | Made with |
| | Zeolite 1 | Zeolite 2 | Zeolite 3 | Zeolite 1 | Zeolite 2 | Zeolite 3 |
| | and La | and La | and La | and Y | and Y | and Y |
| Na₂O on | 8.7 | 22.8 | 32.5 | 8.4 | 24.5 | 34.9 |
| Zeolite | | | | | | |
| (μg/m²) | | | | | | |
| Cat-to-Oil | 4.9 | 6.2 | 7.0 | 4.8 | 5.8 | 6.3 |
| Dry Gas | 1.6 | 1.6 | 1.6 | 1.5 | 1.6 | 1.7 |
| Total LPG | 18.9 | 17.9 | 17.9 | 18.2 | 18.4 | 18.3 |
| Gasoline | 52.8 | 53.6 | 53.6 | 53.5 | 53.0 | 53.0 |
| LCO | 18.5 | 18.6 | 18.3 | 18.5 | 18.5 | 18.5 |
| Bottoms | 5.5 | 5.4 | 5.6 | 5.5 | 5.5 | 5.4 |
| Coke | 2.8 | 3.0 | 3.0 | 2.8 | 3.0 | 3.1 |

It is shown from Table 5 that the catalyst 1 and 4 have similar activity. The Cat to Oil required to achieve 76% conversion is about the same for the two catalysts. While as also shown in Table 5, the catalysts 5 and 6 are significantly more active than their La counterparts of 2 and 3. The Cat-to-Oil was lowered by 0.4 for catalyst 5 when comparing against catalyst 2 and was lowered by 0.7 for catalyst 6 when comparing against catalyst 3. This demonstrates that the yttrium-containing catalysts are much more sodium tolerant than the La containing catalysts while yielding a higher activity.

What is claimed is:

1. A catalyst comprising
(a) zeolite,
(b) yttrium compound, and
(c) sodium, wherein the sodium is present in the catalyst in an amount of at least 18.6 μg per square meter of zeolite surface area.

2. A catalyst according to claim 1, wherein the zeolite is faujasite.

3. A catalyst according to claim 1, wherein the zeolite is selected from the group consisting of type Y zeolite, type X zeolite, Zeolite Beta, and heat treated derivatives thereof.

4. A catalyst according to claim 1, wherein the zeolite is type Y zeolite.

5. A catalyst according to claim 1, wherein sodium is present in an amount ranging from 22 to 50 μg per square meter of zeolite surface area.

6. A catalyst according to claim 1, wherein yttrium is exchanged onto the zeolite, and the yttrium is present in the catalyst in an amount ranging from 0.5 to 15% by weight based on the zeolite.

7. A catalyst according to claim 1, further comprising inorganic oxide matrix.

8. A catalyst according to claim 7, wherein the inorganic oxide matrix comprises a compound selected from the group consisting of alumina, silica, silica alumina, and mixtures thereof.

9. A catalyst according to claim 7, wherein the inorganic oxide matrix comprises alumina formed from peptized alumina.

10. A catalyst according to claim 9, wherein the peptized alumina is based on pseudoboehmite or boehmite.

11. A catalyst according to claim 7, wherein the inorganic oxide matrix comprises silica from a silica sol.

12. A catalyst according to claim 1, wherein the catalyst is in the form of particulate having an average particle size in the range of 20 to 150 microns.

13. A catalyst according to claim 1, further comprising rare earth in a weight ratio with yttrium of 0.01 to 1.

14. A catalyst according to claim 1 comprising zeolite in the range of 1 to 80% by weight of the catalyst, sodium is present in the amount in the range of 22 to 50 μg per square meter of zeolite surface area, and yttrium compound is present in the range of 0.5 to 15% by weight zeolite.

15. A process for making a catalyst, the process comprising
(a) selecting a zeolite having a sodium content of at least 1.3% by weight sodium,
(b) combining the zeolite with a yttrium compound, and
(c) forming a catalyst comprising the zeolite, sodium and yttrium compound.

16. A process according to claim 15, wherein the zeolite in (b) is further combined with inorganic matrix precursor.

17. A process according to claim 16, wherein the inorganic oxide matrix precursor comprises a member of the group consisting of alumina, silica, silica alumina, and mixtures thereof.

18. A process according to claim 16, wherein the inorganic oxide precursor is peptized alumina.

19. A process according to claim 18 wherein the peptized alumina is based on hydrated alumina.

20. A process according to claim 18 wherein the peptized alumina is based on pseudoboehmite or boehmite.

21. A process according to claim 15 wherein the catalyst is formed by spray drying the combination in (c).

22. A process according to claim 21 wherein the catalyst is in the form of particulate having an average particle size in the range of 20 to 150 microns.

23. A process according to claim 15 wherein the yttrium compound is an yttrium salt soluble in water or in acid.

24. A process according to claim 15 wherein the yttrium compound is selected from the group consisting of yttrium halide, yttrium nitrate, yttrium carbonate, yttrium sulfate, yttrium oxide and yttrium hydroxide.

25. A process according to claim 15 wherein the yttrium compound further comprises rare earth in a ratio by weight of rare earth oxide to yttrium oxide in the range of 0.01 to 1.

26. A process according to claim 15 wherein the zeolite is selected from the group consisting of type Y zeolite, type X zeolite, Zeolite Beta, and heat treated derivatives thereof.

27. A process according to claim 26 wherein the zeolite is zeolite USY.

28. A process according to claim 15, wherein the zeolite comprises sodium in the range of 22 to 50 μg per square meter of zeolite surface area.

29. A process according to claim 16, wherein the sodium containing zeolite, yttrium compound and inorganic oxide matrix precursor are combined in an aqueous medium and spray dried into a particulate having an average particle size in the range of 20 to 150 microns.

30. A catalytic cracking process comprising:
(a) introducing a hydrocarbon feedstock into a reaction zone of a catalytic cracking unit comprised of a reaction zone, stripping zone, and a regeneration zone, which feedstock is characterized as having a sodium content in the range of 0.5 to 5 ppm and having an initial boiling point from about 120° C. with end points up to about 850° C.;
(b) catalytically cracking said feedstock in said reaction zone at a temperature from about 400° C. to about 700° C., by causing the feedstock to be in contact with a fluidizable cracking catalyst comprising:
(i) zeolite,
(ii) yttrium in the range of 5 to 15% by weight based on the zeolite, and
(ii) optionally inorganic oxide matrix,
(c) stripping recovered used catalyst particles with a stripping fluid in a stripping zone to remove therefrom some hydrocarbonaceous material; and
(d) recovering stripped hydrocarbonaceous material from the stripping zone and circulating stripped used catalyst particles to the regenerator or regeneration zone; and regenerating said cracking catalyst in a regeneration zone by burning-off a substantial amount of coke on said catalyst, and with any added fuel component to maintain the regenerated catalyst at a temperature which will maintain the catalytic cracking reactor at a temperature from about 400° C. to about 700° C.; and
(e) recycling said regenerated hot catalyst to the reaction zone.
